(19) United States
(12) Patent Application Publication
(10) Pub. No.: US 2009/0031881 A1
(43) Pub. Date: Feb. 5, 2009

(54) Zinistesia: An Apparatus And Method For Teaching, Writing, And Reading Music

(76) Inventor: Fabio Zini, Hallandale Beach, FL (US)

Correspondence Address: JOHN C. SMITH, ESQ., 2499 GLADES ROAD, SUITE 113, BOCA RATON, FL, 33431, US

(21) Appl. No.: 12/178,585

(22) Filed: Jul. 23, 2008

Related U.S. Application Data
(60) Provisional application No. 60/952,843, filed on Jul. 30, 2007.

(51) Int. Cl. G09B 15/02

(52) U.S. Cl. 84/477 R

(57) ABSTRACT

A system and method of identifying the parts and components of a musical work, where analysis and time dedicated to studying are combined in a color based system which uses multicolor musical scores to indicate specific components of the musical work. Each of the components of the musical score, such as melody or theme, transition or bridge, accompaniment, counter-song, coda, etc., is denoted by separate colors. In addition, the most difficult sections of a musical work are identified by indicia to assist the student or musician when learning a particular musical work.

### CROSS-REFERENCE TO RELATED APPLICATIONS

This application is related to, and claims the benefit of, the provisional patent application entitled “Zinistesia: An Apparatus and Method for Teaching, Writing, and Reading Music”, filed Jul. 30, 2008, bearing U.S. Ser. No. 60/952,843 and naming Fabio Zini, the named inventor herein, as sole inventor, the contents of which is specifically incorporated by reference herein in its entirety.

### BACKGROUND OF THE INVENTION

1. Technical Field

The present invention relates to a method of teaching, writing and reading music. In particular, it relates to the use of color to indicate the different components of a musical score, such as melody or theme, transition or bridge, accompaniment, counter-song, coda, etc. In addition, the invention provides a new method of assisting disabled individuals when teaching music.

2. Background

Since the written musical scores were first used, musical signs were the main basis for writing music, and, until now, music was written solely and exclusively in black and white. This has lead to frustration and confusion when it comes to reading music because of the alternation that occurs when looking at the instrument and then at what is written, i.e. the score.

A disadvantage associated with prior art musical scoring systems is that it is sometimes difficult to tell which component of any musical score is being played, especially when the musician is learning a particular musical piece, or when the musician is in the middle of a performance. It would be bizarre to have a method of indicating to the musician the nature of the particular portion of the musical score which is being played.

Another disadvantage associated with prior art musical scoring systems is that, when teaching a student who is unfamiliar with musical scores, it is often difficult on an experienced student to determine which component of the musical score is being played.

A substantial difficulty for students when studying music is learning how to analyze a score. Prior art musical scores do not provide any visual cues to the student, to the accomplished musician.

Another problem related to teaching stringed instruments, such as guitar is that there are ongoing disagreements as to how best to annotate a score. In particular, there are disagreements as to whether to keep voices on separate stems or to combine them onto a single stem when convenient. It would be desirable to have a method of annotating voices which are easily discernible to the eye.

The previous discussion focused on the problems encountered by students when attempting to learn music. However, prior art music scores provide disadvantages for other individuals as well. In particular, in the case where a physically handicapped individual is attempting to teach music, prior art musical scores provide little help for that individual. Due to a handicap, a teacher may not be able to physically show how difficult individual sections of a musical work are. For example, instruments which require a great deal of finger dexterity, such as guitar or piano, may be impossible for a disabled person to teach because they cannot manually demonstrate a section of music to a student. It would be desirable to have a method of teaching music which would allow a disabled instructor to discuss and teach difficult sections of the musical score without requiring the physical ability of the teacher to demonstrate the music.

Prior art systems have failed to provide an easy to understand method of indicating the components of the musical score, which allows a student or practicing musician to rapidly recognize and understand which component of a particular musical score is being played, and which assist disabled instructors to teach musical scores without having to demonstrate each piece.

### SUMMARY OF THE INVENTION

The present invention provided herein uses a new and innovative method of identifying the parts and components of a musical work, where analysis, time, and time dedicated to studying and analyzing musical works are combined in a new learning concept called “Zinistesia.” Zinistesia is a system which uses multicolor musical scores to indicate specific components of the musical work. In Zinistesia, each of the components of the musical score, such as melody or theme, transition or bridge, accompaniment, counter-song, coda, etc., are denoted by separate colors. As a result, the student or musician will instantly know which component of the musical score is being played. This allows the student or musician to learn more quickly, and to concentrate one other aspects of the performance without taking time to determine which component of the musical score they are playing at any given moment.

### BRIEF DESCRIPTION OF THE DRAWINGS

FIG. 1 illustrates a musical composition written using the prior art black and white method.

FIG. 2 illustrates a musical composition written using a preferred embodiment of the invention in which color codes indicate the components of the musical score.

FIG. 3 further illustrates a musical composition written using a preferred embodiment of the invention in which color codes indicate the components of the musical score.

FIG. 4 further illustrates a musical composition written using a preferred embodiment of the invention in which color codes indicate the components of the musical score.

FIG. 5 further illustrates a musical composition written using a preferred embodiment of the invention in which color codes indicate the components of the musical score.

FIG. 6 illustrates a preferred embodiment of a musical composition written for guitar using color codes to indicate the components of the musical score and tablature.

FIG. 7 illustrates a preferred embodiment of a musical composition which shows an example of how the introduction in a musical score is illustrated.

FIG. 8 illustrates the use of indicia to identify the more difficult segments of a musical work.

### DESCRIPTION OF THE PREFERRED EMBODIMENT

The Zinistesia system used in this invention provides a novel method of color coding components of musical scores. In addition, it provides a method of teaching new music students so that they learn the organization of music more rapidly than heretofore possible, and they are able to more rapidly analyze a musical score. Likewise, it assists experienced musicians by providing them the ability to instantly understand what component of the musical score they are playing at any given point in time. In addition, the color based Zinistesia system provides significant advantages to disabled individuals, especially those who are attempting to teach guitar.

In addition to enhancing the ability to teach students, the Zinistesia system also provides a powerful new tool for disabled music instructors to teach different sections of a musical work even though they may be physically unable to demonstrate each section. In particular, through the use of a color-coded system described below, the instructor can discuss how each section of a musical work is played without any confusion which would be caused by monochrome prior art systems. Further, it allows a handicapped teacher who is unfamiliar with a particular musical score to better understand the various components of the music without having to actually play it.

The Zinistesia system is based on the use of color to increase the understanding of music. This unique new system adds color to the musical notation of the pentagram. This provides a substantial advantage in that it helps the musician better understand the work and facilitates the study of its structure. Significantly, the Zinistesia system will benefit anyone interested in music, including beginners, fans, students or experienced professionals who want to analyze a musical work. The Zinistesia color system assists users of the system by providing visual information to students and/or professionals to help them instantly determine which part of the music is being played at any given point in time. In addition, the use of color provides significant advantages to musicians, students, and teachers in terms of their ability to understand issues related to voice separation. This is because a color based system allows an individual to see the voices.

The Zinistesia color system also aids in the analysis of the musical work. Analysis is of great importance to the musicians so they can reach the major rigour, solidity and depth of a performance. The analysis of the musical score helps the comprehension of the writing and helps the student identify the components of the piece, and will help them distinguish the melodies of the accompaniments.

The system also visually identifies the portions of a musical work in which a technical problem or fingering problem is most likely to occur. The fingering problem is marked using an indicia. For example, the indicia can be a beam length angle, up or down from the staff, using any color. However, those skilled in the art will recognize that any suitable indicia can be used. It will mark part or all of the staff or measure or sequence or passage that contains technically difficult fingerings. This allows the teacher and student to identify the portions of the piece which are the most technically difficult. By mastering these portions, the remainder of the musical work will be relatively easy to learn and play through the whole piece.

The system also allows the musician to identify the more complex components of a musical work. The use of color can help to identify technical problems or fingering problems at specific locations within a musical score. Fingering problems can be marked by using a beam which is angled up or down from the staff using any color. In the preferred embodiment it marks all or part of the staff, or measure, or sequence that is difficult. In practice, only small parts of most pieces are difficult to master. By identifying those parts, the student can concentrate on most difficult areas, and once mastered, the remainder of the piece can be easily learned.

In addition, there are also problems associated with notes which appear above or below the five line staff. These are typically represented using ledger lines. However these can be difficult to read. The invention uses colors to identify the ledger lines to make the work easier to read.

The assimilation of the polyphony is complex. In the case of the guitar, piano, etc., it requires of the analysis and the comprehension of problems which are specific to the nature of those particular instruments. The problems of the interpretation of the polyphony present probably common problems by learning of all the polyphonic instruments. However, the guitar presents some specific problems that complicate the learning process for students who study it. In the left hand of the guitar player all the voices are distributed among the four fingers with some pre-determined fingers representing some voices and some fingers representing other voices. For the right hand, things are at times a little clearer. For example, the thumb is used almost exclusively for the base line, and in some studies and works, the ring should play a melody in the upper voice. In comparison to other polyphonic instruments, we can observe as in the harp and in the instruments of keyboard the different voices are distributed among both more logical hand forms: melodies in one hand and accompaniments in the other, or as in polyphony with two voices (one for each hand).

Normally, in a music score for guitar, a teacher will indicate to the student that they should play by separating the different voices. However, this is difficult for students to distinguish. In fact, typically a student will recognize almost any succession of sounds as a melody. As a result, the student does not note the loss of cohesion which is intersperses alien elements into the melody.

On the other hand, using the Zinistesia system, the student will first play the melody then the accompaniment, and finally play all components of the musical score at once. This permits the student to better understand and analyze the musical score which results in a better performance. Understanding and analyzing a musical score is an indispensable condition for a good interpretation of the polyphonic musical score. The Zinistesia system provides the student this understanding and analysis.

An important component of any good musical performance is controlling the intensity that should apply to each note, giving more highlight to those that constitute the most outstanding parts of the musical score, for example, “Melody”, and a smaller dynamic intensity to the accompaniments and to the parts less prominent of the polyphony. These different levels of intensity are known in musical interpretation as plans sonorous or flat dynamic and they are indispensable to provide the listener with the necessary clarity. Pianist Heinrich Neuhaus (1888-1964) said that a common error, even among the advanced students, is the dynamic approximation of the melody and of the accompaniment: This “lack of air” between two or more plans, is as damaging when heard as would damage to a picture be to the eye.

Music for guitar is written in a single staff. The melody and the accompaniment is played by a single hand, the guitarist should distinguish with clarity each one of the voices and to emphasize the melody. Also we can find melody, accompaniment, countermelody or counter-song together in one staff, this creates specific problems when playing the melody and then emphasizing voices, first melody then accompaniment, etc. Often, the guitarist will play all things with a same dynamic intensity. In music piano scores, notes is writing in two staffs, we can find melody in one staff and accompaniment in the second staff but also we can find melody and countermelody or counter-song, etc. in one staff. This also creates specific problems. Sometimes professional musicians don't know which voice is the melody or where the melody is going. Melody-accompaniment mixed together or melody-countermelody mixed together can also be confusing for both students and professionals.

An advantage provided by the Zinistesia system is that it provides the musician with a much more accurate, fast, and safe reading. In particular, while Zinistesia will benefit all lovers of music who read musical scores, it will provide an especially useful benefit to musicians and students who will be able to quickly visualize the difference between melody or theme, transition or bridge, accompaniment, counter-song, coda, etc., at the first sight of the score.

A further advantage provided by the Zinistesia system is that because various parts of a musical piece are clearly identified by the difference in colors, it allows students and professionals to memorize more extensive and complex pieces in a shorter period of time and in a more efficient manner. This is based on the psychological point of view that colors promote a higher level of concentration, and enhance the musician's memory in regard to a particular musical work.

The Zinistesia system does not change the manner in which music is studied or written; it simply adds a color code to the pentagram. Thus, players can separately and immediately focus on all the elements of the musical language, which benefits learning and perfects the teaching systems. Further, because it does not change the way in which music is studied or written, it is entirely compatible with everything a student or musician has learned using the prior art. The Zinistesia system takes the prior art as it is and improves it by adding a color dimension.

In the preferred embodiment of the Zinistesia system, the components of a musical score defined by the following four colors:
A. RED=Melody or theme or first element or first material or subject.
B. BLUE=Accompanying texture (i.e. bass, harmony, etc.).
C. GREEN=Introduction, transition or bridge, episode and coda.
D. BLACK=Countermelody or counter-song or counter subject.

Those skilled in the art will recognize that additional colors may be added. However, the limited selection of colors used in the preferred embodiment is intended to simplify the reading and writing of music and avoid any complexity and confusion. Likewise, those skilled in the art will also recognize that while particular colors are assigned to specific components of the musical score, above, different colors can be used, or the same colors can be used but assigned to different components.

In regard to the annotation of voices in a musical score, as noted above, there are disagreements as to whether to keep voices on separate stems or to combine them onto a single stem when convenient. The invention allows the composer to keep the voices on separate stems or to combine them when convenient. In either case, the use of color allows the various components of the music to be visually distinct to delineate each voice while avoiding a cluttered appearance that is difficult to read. In particular, the guitar should be written in two locations: G-Clef located in G, on the second line of the staff, and F-Clef located on the fourth line of the staff.

The dynamic character which color adds to a score depends on the musical language or organization given by the composer to the composition of a particular piece. Zinistesia provides an improvement in reading music for both the novice musician, and the experienced professional. In addition, the use of color makes reading music more enjoyable and, as a result, color encourages musicians to practice more, as well enhance their enjoyment when performing.

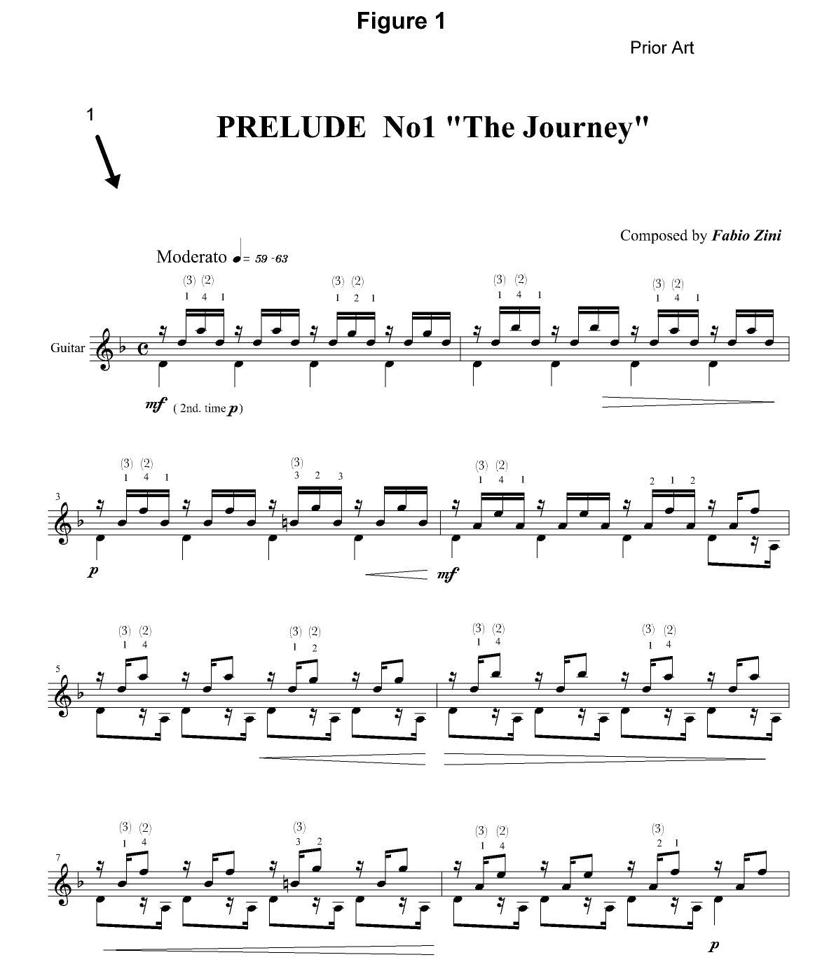

FIG. 1 illustrates an example of a musical composition written using the prior art black and white method. As can be seen in this figure, the musical score 1 is printed in the traditional prior art manner, namely black and white. In addition, the stem arrangement makes it difficult to visually identify the various components of the musical work. A disadvantage associated with this method is that it is not immediately obvious which section of the musical score is being played. This is especially true for novice musicians who are still learning to play.

As a result of the difficulty and frustration associated with learning musical scores, the time needed to learn how to play a musical score is substantial, and some novice musicians may decide to abandon training due to the difficulties involved with learning how to read and play sheet music.

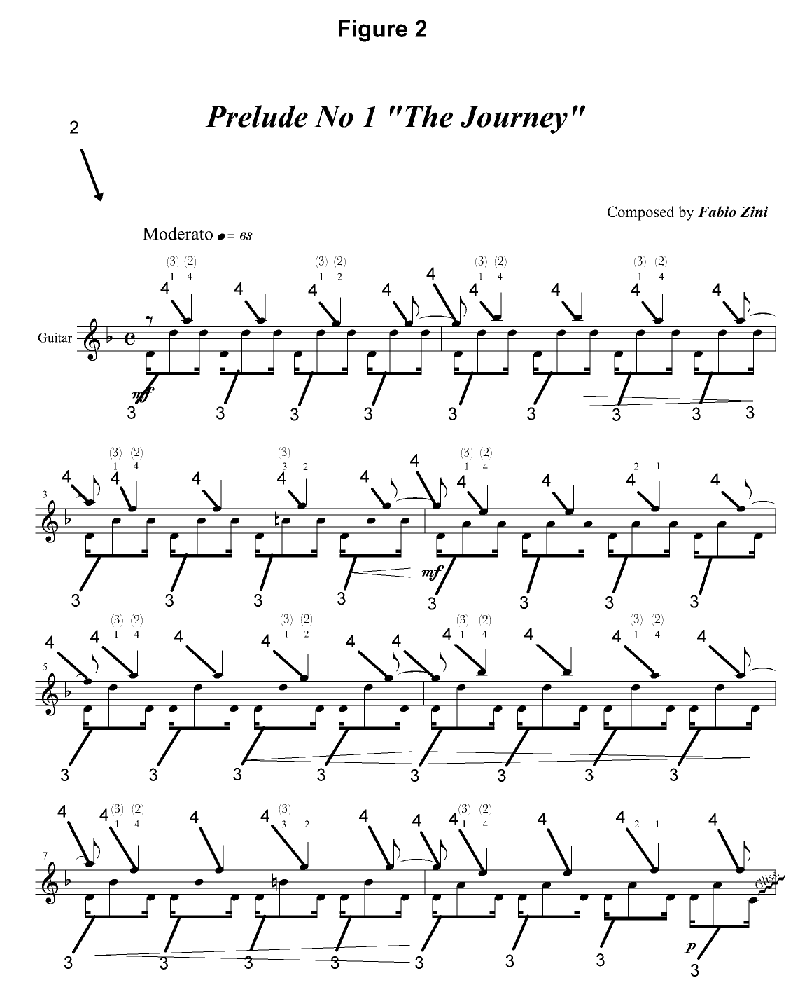

FIGS. 2-7 illustrate a musical composition written using a preferred embodiment of the invention in which color codes indicate the components of the musical score 2.

In FIG. 2, a preferred embodiment of the invention is illustrated. In this case, the same musical score illustrated in FIG. 1 is used. However, in this embodiment, the Zinistesia color system is used to enhance the readability of the musical score 2.

As shown in this figure, the melody 4 is printed in red. In addition, the accompanying texture 3 is printed in blue. This immediately conveys to the musician the nature of each and every note on the page. As a result, the musician is better able to interpret the musical score and to give a better performance.

In addition to the use of color, this figure, as compared to FIG. 1, also rearranges the stems. By rearranging the stems in this manner, the various components of the musical work are more easily identified, even though the musical work remains unchanged from that in FIG. 1.

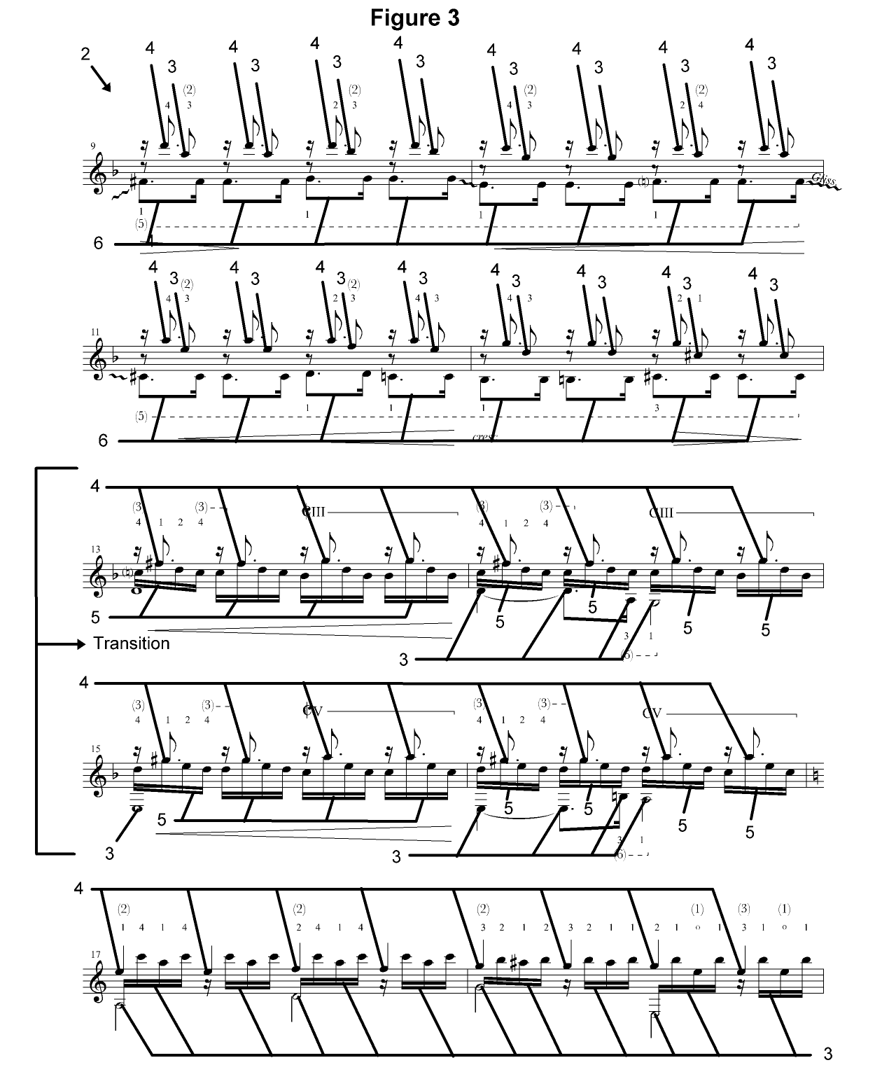

FIG. 3 further illustrates a musical composition written using a preferred embodiment of the invention in which the Zinistesia color system indicates the components of the musical score 2. In this figure, the melody 4, and the accompanying texture 3 are shown. And in addition, the transition 5 and countermelody 6 are also shown.

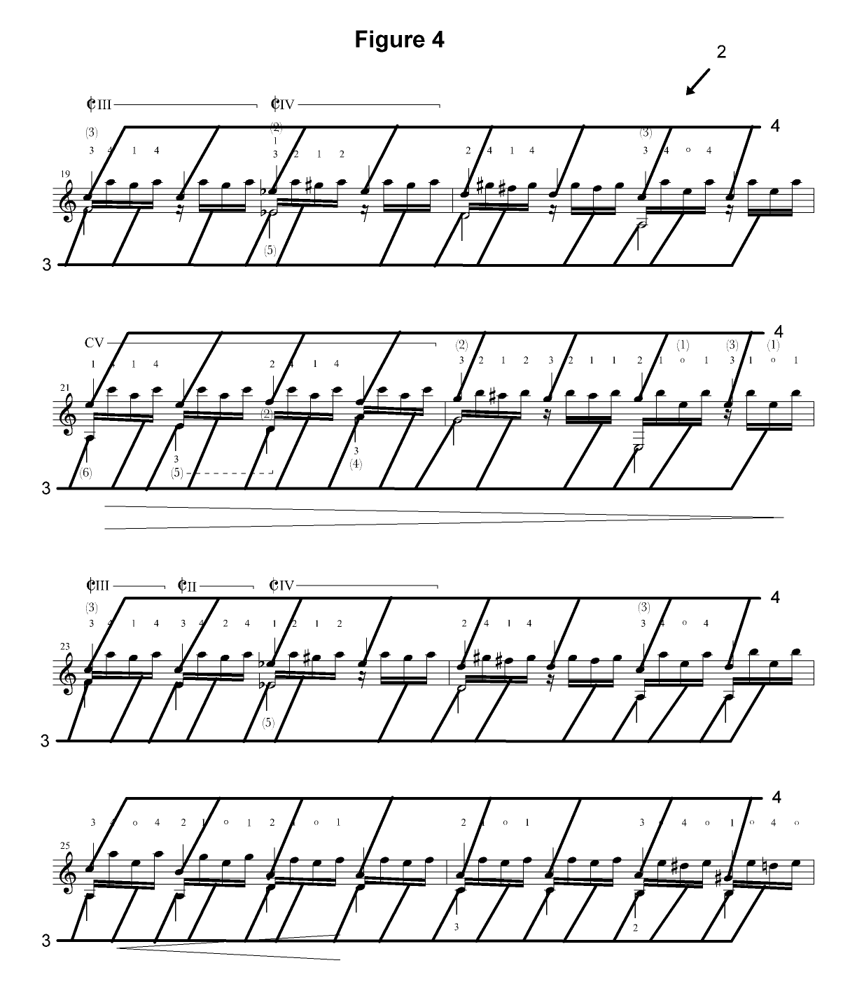

FIG. 4 further illustrates a musical composition written using a preferred embodiment of the invention in which the Zinistesia color system indicates the components of the musical score 2. This figure illustrates the third page of the musical score 2 discussed at fault in regards to FIGS. 2-3. In this figure, the melody 4 comprises the bulk of the information on the sheet. In addition, a small portion of accompanying texture 3 is also shown. This also assists the musician in that it can be easy to overlook small items of information such as the relatively small amount of accompanying texture 3 is shown on this sheet.

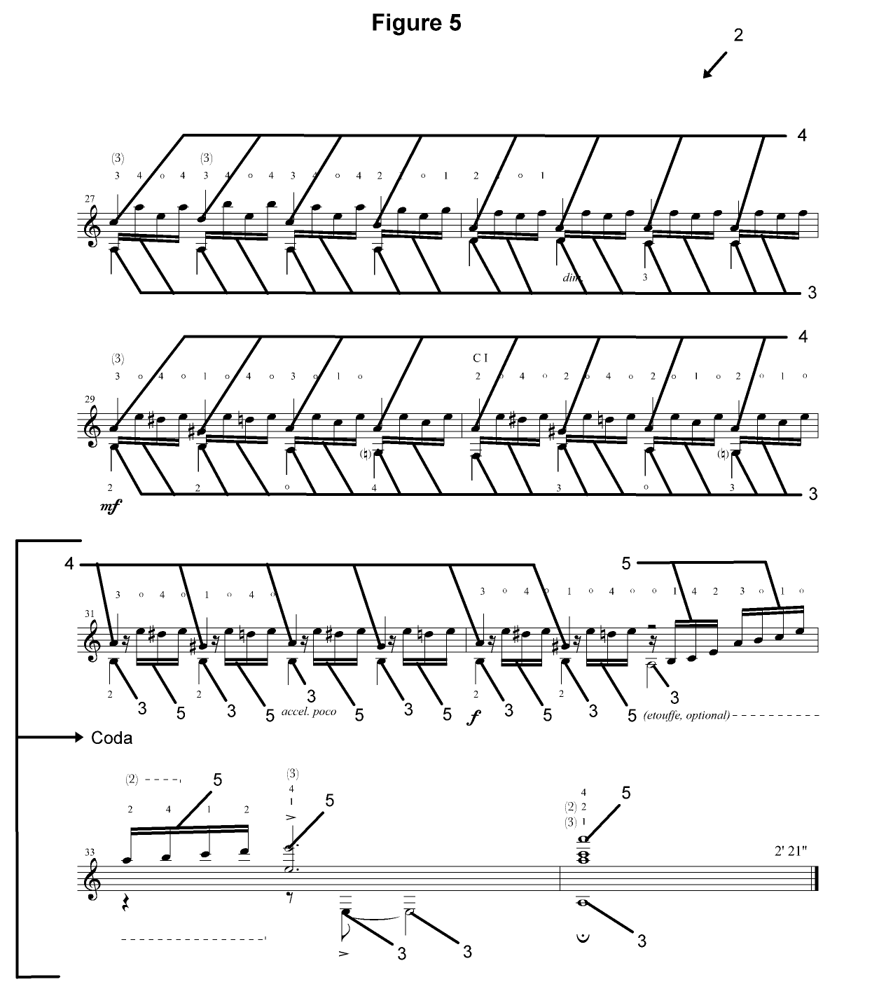

FIG. 5 further illustrates a musical composition written using a preferred embodiment of the invention in which the Zinistesia color system indicates the components of the musical score 2. Again, this sheet indicates the melody 4, accompanying texture 3, and coda 5 components of the musical score.

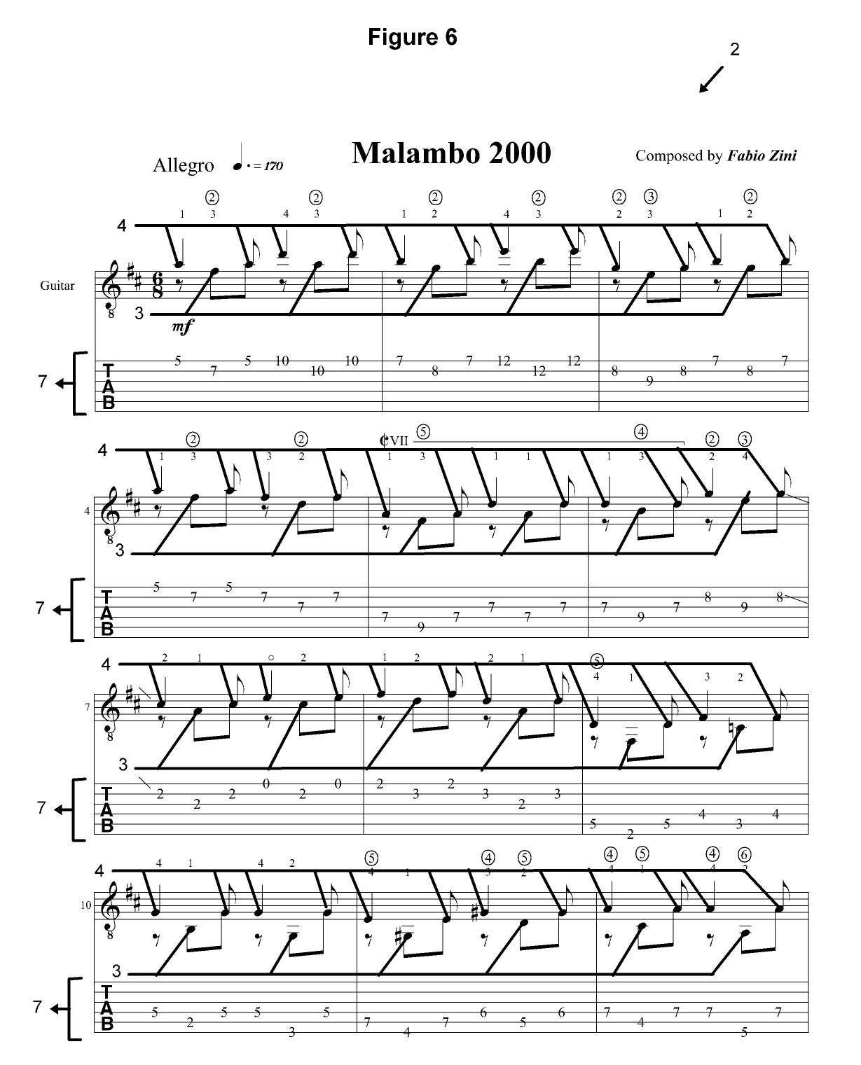

FIG. 6 illustrates another musical composition which is written for guitar. As can be seen, the coding system can be adapted to any instrument. This is important because some instruments are more difficult to learn than others. Regardless of the level of difficulty, the color coding system used herein provides every student with the same learning benefits.

This figure also illustrates how the invention can be used for musical score formats that are unique to particular instruments. As shown in FIG. 6, the tablature 7 for guitar uses numbers which are also in color. The tablature 7 provides a quick reference for locating the guitarist's fingers at the proper string and the proper string finger location on the guitar. This allows the guitarist to use the same Zinistesia color system for both the musical score and the tablature 7. As a result, all phases of the musical work can be more clearly understood by the artist.

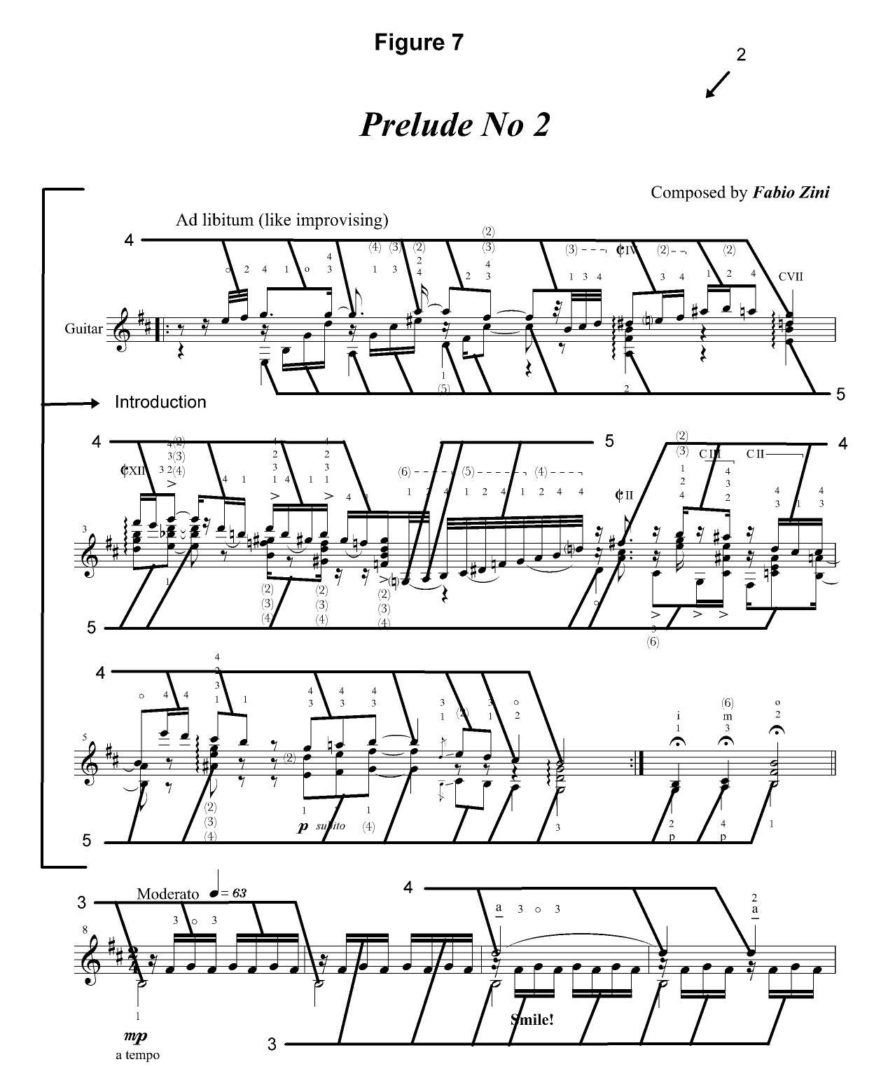

FIG. 7 illustrates a preferred embodiment of the invention in which the introduction 5 of a musical score 2 is illustrated.

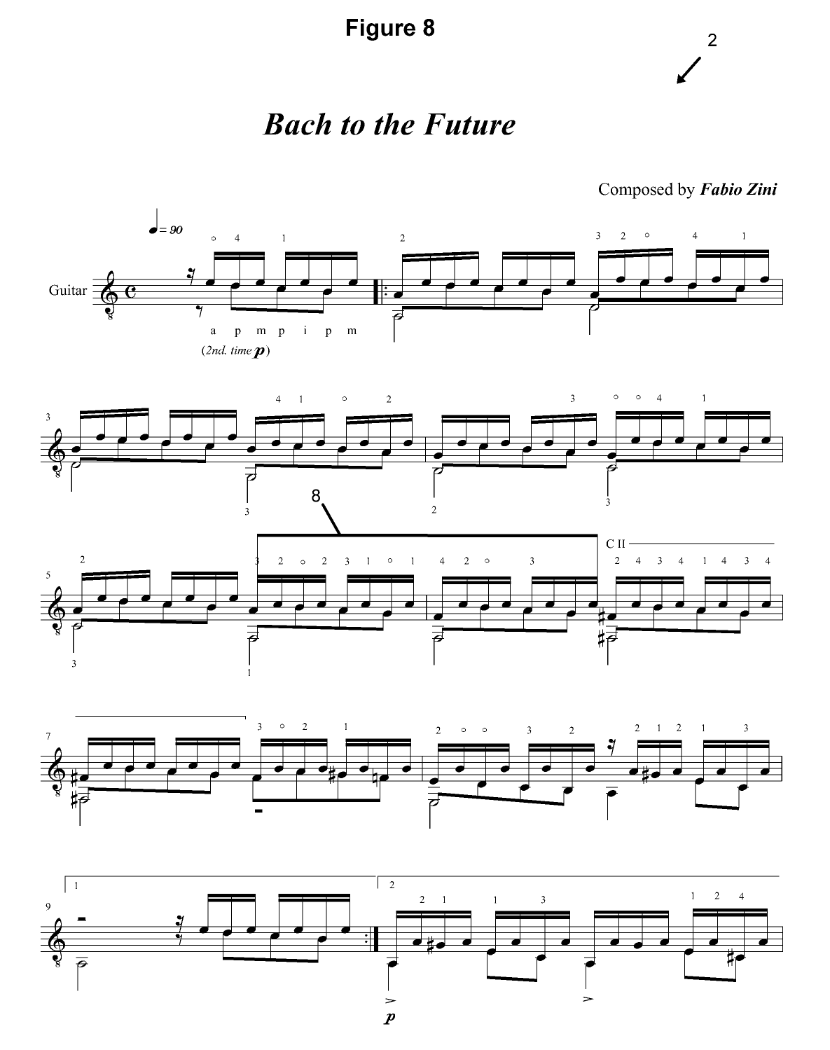

FIG. 8 illustrates the use of indicia 8 to identify the more difficult segments of a musical work. By visually identifying the more difficult portions of a musical work in which a technical problem or fingering problem is most likely to occur, the student can then master those portions first. Learning the rest of the work will be relatively easy. The difficult portions are marked using indicia 8. In the preferred embodiment, indicia 8 is a horizontal line which connects the first and last notes of the difficult. However, those skilled in the art will recognize that any suitable indicia can be used, as well as any color. As shown, indicia 8 marks part or all of the staff or measure or sequence or passage that contains technically difficult fingerings.

While the invention has been described with respect to a preferred embodiment thereof, it will be understood by those skilled in the art that various changes in detail may be made therein without departing from the spirit, scope, and teaching of the invention. For example, the color is associated with a particular musical component can vary, the number of colors used in very, etc.

I claim:

1. A method of annotating a musical score, including the step of:
assigning preselected colors to notes of a musical score that indicate which component of the musical score and notes are a part of, such that, when reading for musical score, particular notes in each component of the musical score will be represented by a predetermined color.

2. A method, as in claim 1, including the additional step of:
assigning a preselected color to indicate the notes of a musical score that comprise the melody or theme or first element or first material or subject component of the musical score.

3. A method, as in claim 2, including the additional step of:
indicating the melody or theme or first element or first material or subject component of the musical score with the color red.

4. A method, as in claim 1, including the additional step of:
assigning a preselected color to indicate the notes of the musical score that comprise the accompanying texture component of the musical score.

5. A method, as in claim 4, including the additional step of:
indicating the accompanying texture component of the musical score with the color blue.

6. A method, as in claim 1, including the additional steps of:
assigning a preselected color to indicate the notes of the musical score that comprise the introduction, transition or bridge, or episode or coda components of the musical score.

7. A method, as in claim 6, including the additional step of:
indicating the introduction, transition or bridge, or episode or coda components of the musical score with the color green.

8. A method, as in claim 1, including the additional step of:
assigning a preselected color to indicate the notes of the musical score that comprise the countermelody or counter-song or counter-subject component of the musical score.

9. A method, as in claim 8, including the additional step of:
indicating the countermelody or counter-song or counter-subject component of the musical score with the color black.

10. A method, as in claim 1, including the additional step of:
indicating difficult technical or fingering sections of a musical work by using indicia positioned near the difficult technical or fingering area;
whereby a musician can identify and learn the more difficult portions of a musical work prior to playing the entire musical work.

11. A system for annotating the musical score, comprising:
a multicolored musical score sheet in which various notes of the musical score are assigned preselected colors that indicate which component of the musical score the notes are a part of;
whereby a musician, teacher, or student can quickly identify the components of a musical work based on color.

12. A system, as in claim 11, wherein:
the melody or theme or first element or first material or subject component of the musical score is assigned a first predetermined color.

13. A system, as in claim 12, wherein:
the first predetermined color is red.

14. A system, as in claim 11, wherein:
the accompaniment texture component of the musical score is assigned a second predetermined color.

15. A system, as in claim 14, wherein:
the second predetermined color is blue.

16. A system, as in claim 11, wherein:
the introduction, transition or bridge, or coda component of the musical score is assigned a third predetermined color.

17. A system, as in claim 16, wherein:
the third predetermined color is green.

18. A system, as in claim 11, wherein:
the countermelody or counter song component of the musical score is assigned a fourth predetermined color.

19. A system, as in claim 18, wherein:
the fourth predetermined color is black.

20. A system, as in claim 11, wherein:
indicating difficult technical or fingering sections of a musical work by using indicia positioned near the difficult technical or fingering area;
whereby a musician can identify and learn the more difficult portions of a musical work prior to playing the entire musical work.
